(19) United States
(12) Patent Application Publication
(10) Pub. No.: US 2014/0348198 A1
(43) Pub. Date: Nov. 27, 2014

(54) LASER WITH IMPROVED RADIO FREQUENCY ENERGY DISTRIBUTION

(71) Applicants: Gerald L. Kern, Wadena, MN (US); Darryl Nelson, Wadena, MN (US); Nathan Monty, Shrewsbury, MA (US)

(72) Inventors: Gerald L. Kern, Wadena, MN (US); Darryl Nelson, Wadena, MN (US); Nathan Monty, Shrewsbury, MA (US)

(21) Appl. No.: 14/213,625

(22) Filed: Mar. 14, 2014

Related U.S. Application Data
(60) Provisional application No. 61/790,736, filed on Mar. 15, 2013.

(51) Int. Cl. H01S 3/038; H01S 3/097; H01S 3/03

(52) U.S. Cl. CPC H01S 3/0385; H01S 3/03; H01S 3/09705
USPC 372/55

(57) ABSTRACT

A carbon dioxide slab laser includes a top electrode and a bottom electrode. The top electrode has a socket formed at a geometric center and receives a contact ring in the recess of the socket. The contact ring includes radially inward extending biasing fingers. The biasing fingers contact a radio frequency (RF) energy feed through plug and engages the outer wall of the plug and retains it in the socket. The fingers disperse RF energy radially outward to the laser and provide for more even energy distribution that allows for more power. Grounding is also improved through grounding bars spaced apart longitudinally along the length of the bottom electrode. The transverse extending bars include contact elements having spaced apart fingers along the length of the contact element and providing multiple ground points to prevent focusing at a single grounding point.

### BACKGROUND OF THE INVENTION

1. Field of the Invention

The present invention relates to a vacuum sealed radio frequency feed connection and grounding for a carbon dioxide slab laser.

2. Description of the Prior Art

Carbon dioxide slab lasers are well known and generally have a metal outer housing forming a vacuum chamber with two flat electrodes within the chamber. The electrodes typically have a gap of 1-2 mm. The top electrode has a radio frequency (RF) energy applied to it while the bottom electrode becomes the ground. The vacuum chamber is sealed with a lasing gas contained therein.

Applying RF energy to the electrodes as well as grounding the electrodes in an efficient manner can be a challenge and may be a limiting factor for the laser's power. By providing RF energy to the top electrode, the RF energy applied may result in plasma ionization developing outside the inner vacuum chamber. In particular, past slab laser devices have used a single feed through that may result in the energy being focused at that point and the plasma. being ionized with sparking and/or arcing outside of the vacuum chamber.

In addition, the grounding of the bottom electrode slab also requires eliminating focused electrical grounding paths to prevent further plasma ionization and arcing related with the grounding.

It can be seen that a new and improved slab laser is needed that provides for spreading the radio frequency energy fed to the laser and spreading the energy for grounding. Such a system should provide a simple and inexpensive connection for the infeed as well as the simple and inexpensive grounding configuration that spreads the energy out and provides for handling greater energies without limiting the power of the laser. An improved laser should also achieve plasma ionization spread evenly along both electrodes. The present invention addresses these problems as Well as others associated with slab lasers.

### SUMMARY OF THE INVENTION

The present invention is directed to a vacuum sealed slab laser. The laser generally includes a top electrode and a bottom electrode with a gap forming an inner chamber. The inner chamber may take on various conventional configurations with mirrors or lenses to focus the energy and emit a laser beam. The laser includes an improved radio frequency (RF) input as well as improved grounding to achieve greater power without focusing the power in unwanted locations and achieving greater power through improved dispersion both at input and through grounding.

A recess type socket is formed in an upper surface of the top electrode. The cylindrical recess receives an annular contact ring. The contact ring includes radially inward extending contact biasing fingers that engage and act as a biasing force against an RF feed through plug inserted into the socket and through the contact ring. The plug includes a conductive center shaft and cap portion as well as a ceramic housing. An air gap is created between the ceramic housing and the center shaft. RF energy is dispersed evenly radially outward due to the configuration of the inward extending biasing fingers.

Grounding contacts are also dispersed over the lower surface of the bottom electrode. Gold coating copper grounding bars extend transversely to the longitudinal direction of the laser or may run the length of the electrode. The grounding bars are substantially evenly spaced along the length of the lower electrode. The spaced apart grounding bars create multiple points for grounding and greater spreading so that the ground is not focused at one location. Moreover, the lower surface of each grounding bar includes an elongated contact element with multiple contact fingers extending along the length of the contact element. The contact fingers also provide multiple grounding points on each grounding bar to further prevent focusing a grounding path at a single location. With the grounding bars spaced along the length of the laser body and the contact element including contact fingers extending across the width of the grounding bars, multiple spaced apart grounding points are created both along the width and length of the laser.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

FIG. 1 is a perspective view of a laser with a contact ring and radio frequency feed plug according to the principles of the present invention;

FIG. 2 is an exploded perspective view of the laser shown in FIG. 1;

FIG. 3 is a bottom perspective view of a portion of the laser shown in FIG. 1;

FIG. 4 is a side sectional view of the laser shown in FIG. 1;

FIG. 5 is top perspective view of the socket and contact ring for the laser shown in FIG. 1;

FIG. 6 is a sectional view taken through the plug, contact ring, socket and electrodes of the laser shown in FIG. 1;

FIG. 7 is a perspective view of the contact ring for the laser shown in FIG. 1;

FIG. 8 is a top plan view of the contact ring shown in FIG. 7;

FIG. 9 is a side elevational view of the contact ring shown in FIG. 7;

FIG. 10 is a top perspective view of the plug for the laser shown in FIG. 1;

FIG. 11 is a bottom perspective view of the plug shown in FIG. 10;

FIG. 12 is a side elevational view of the plug shown in FIG. 10;

FIG. 13 is a side sectional view taken along line 13-13 of FIG. 12;

FIG. 14 is a top plan view of the plug shown in FIG. 10;

FIG. 15 is a partially explode top perspective view of the plug shown in FIG. 9; and

FIG. 16 is a perspective view of a grounding element for the laser shown in FIG. 1.

### DETAILED DESCRIPTION OF THE PREFERRED EMBODIMENT

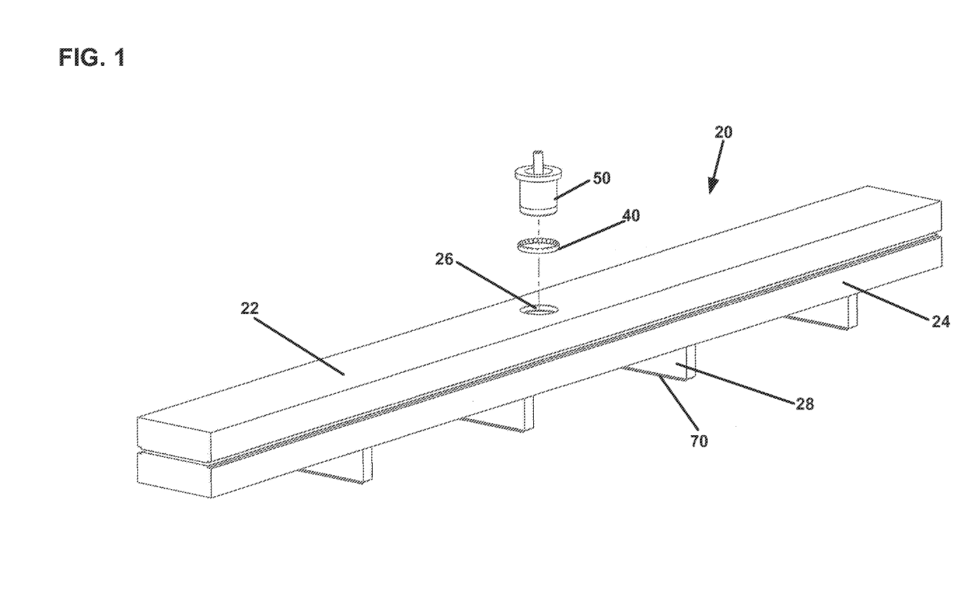

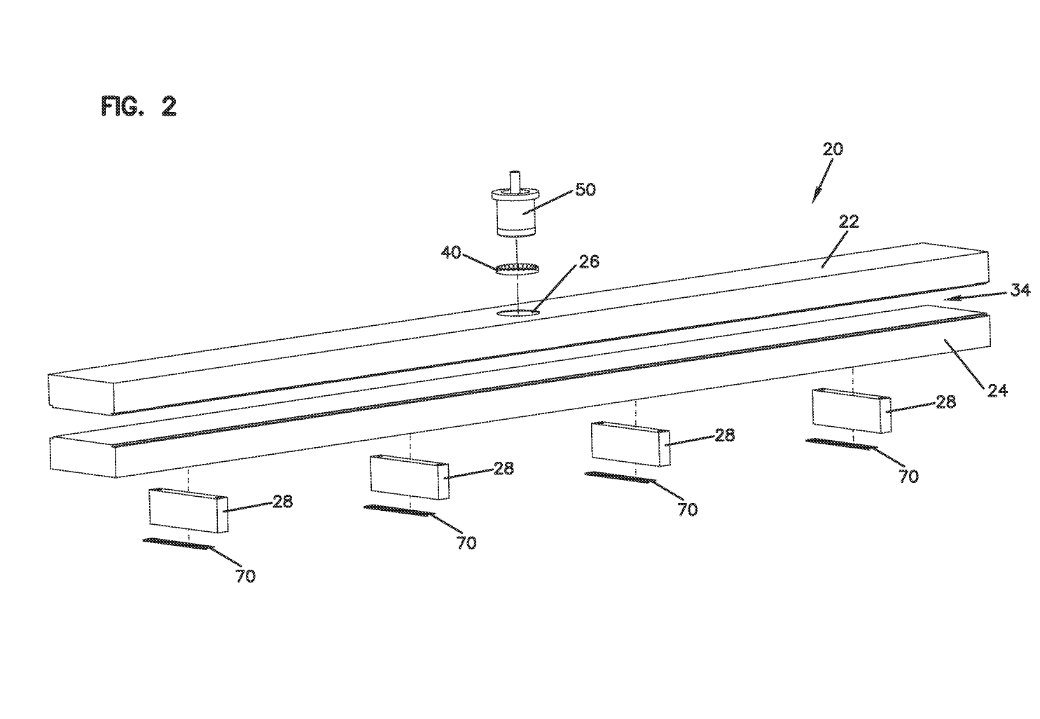

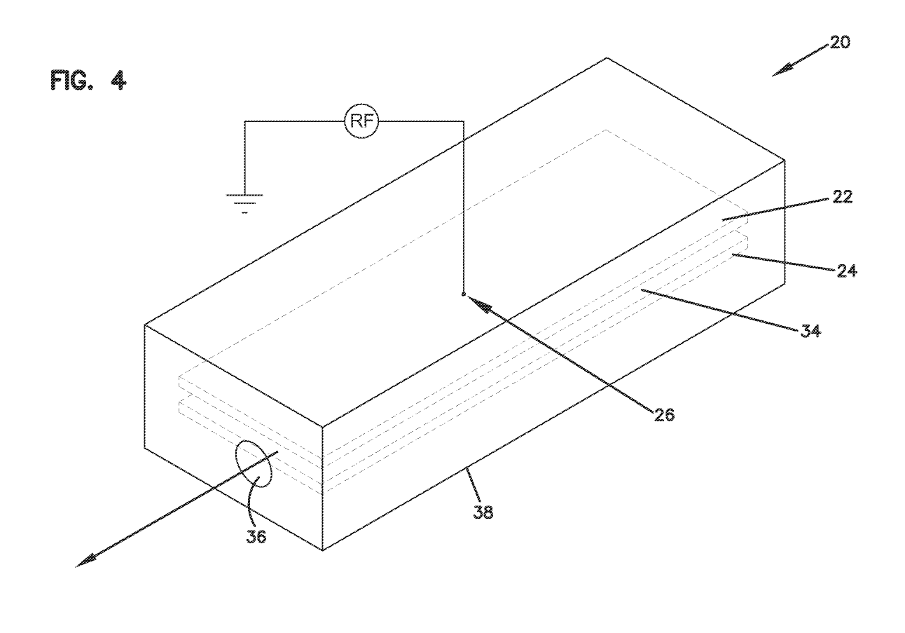

Referring now to the drawings and in particular to FIGS. 1 and 2, there is shown a carbon dioxide slab laser, generally designated (20). The laser (20) includes a top electrode (22) and a bottom electrode (24) in an outer housing (38), as shown in FIG. 4. Gold coated copper grounding bars (28) are spaced along the length of the bottom electrode (24) as shown in FIGS. 1 and 2 to spread the grounding energy over a wide area along the length of the laser (20). The top electrode (22) and bottom electrode (24) are clamped together and vacuum sealed with a gap between the electrodes to form a chamber (34), such as shown in FIG. 4. The radio frequency (RF) energy is fed through a feed plug (50) inserting into a socket (26) on the top of the top electrode (22). The socket (26) holds a contact ring (40) that engages the plug (50) and provides radial dispersion of RF energy. In a preferred embodiment, the socket (26) is placed at the geometric center of the upper surface of the top electrode (22). Such centered positioning provides for even dispersion of RF energy.

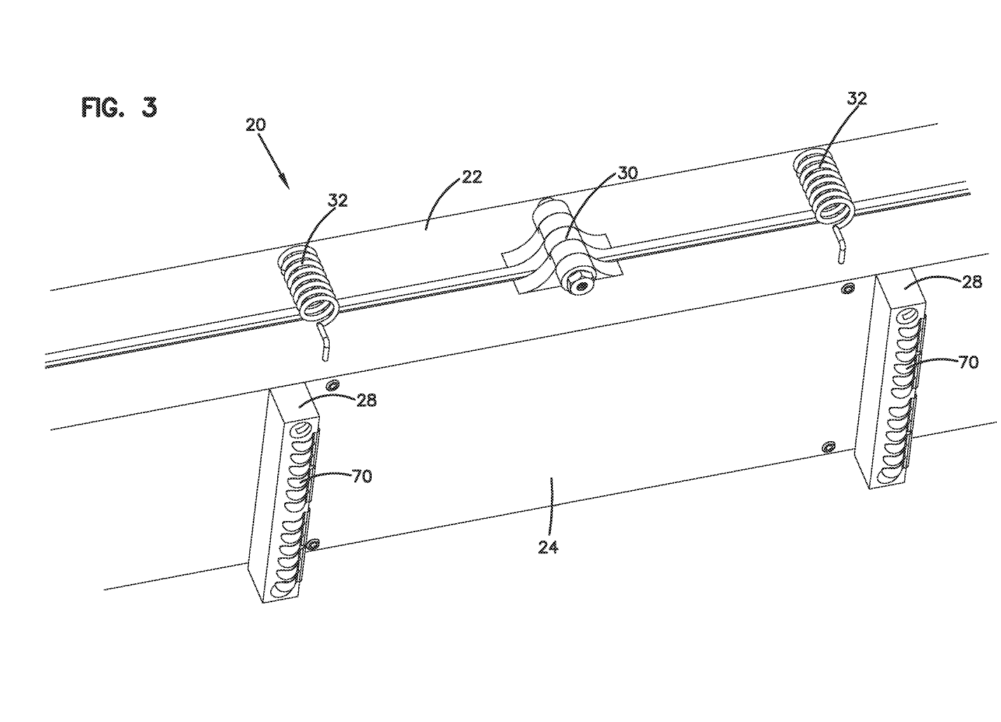

As shown in FIG. 3, the top electrode (22) and bottom electrode (24) may be held together by clamps (30). Inductors (32) are spaced about the periphery of the electrodes and provide a connection between the top electrode (22) and bottom electrode (24). As shown in FIG. 4, a gap is formed within the chamber (34) and includes mirrors or lenses within the chamber and a mixture of lazing gas. When energized, the laser creates a focused laser beam that is emitted at an output (36).

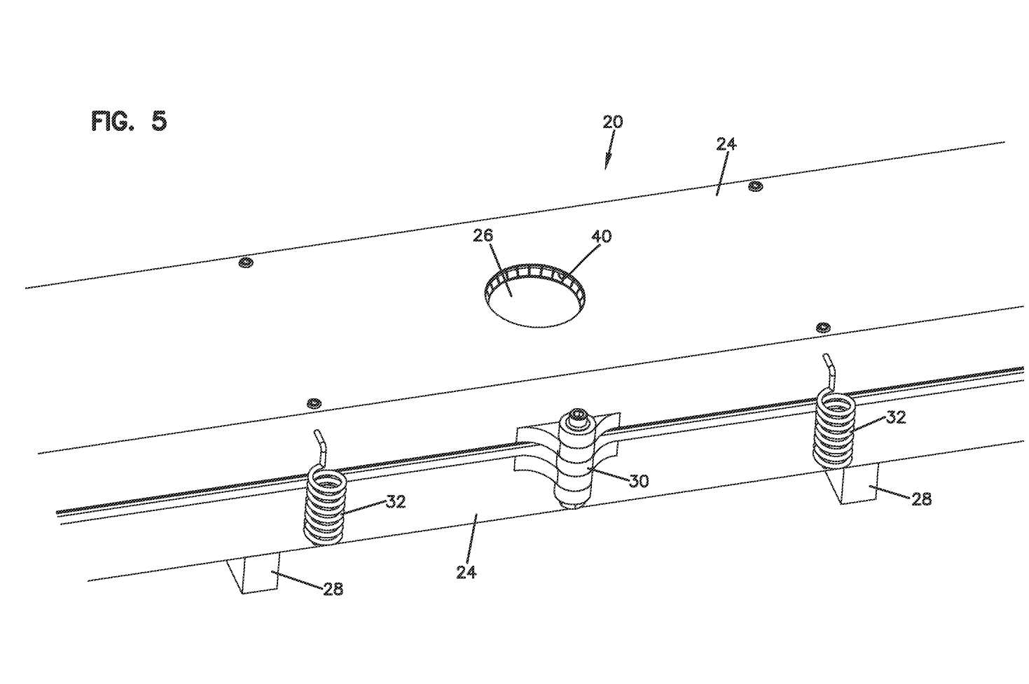

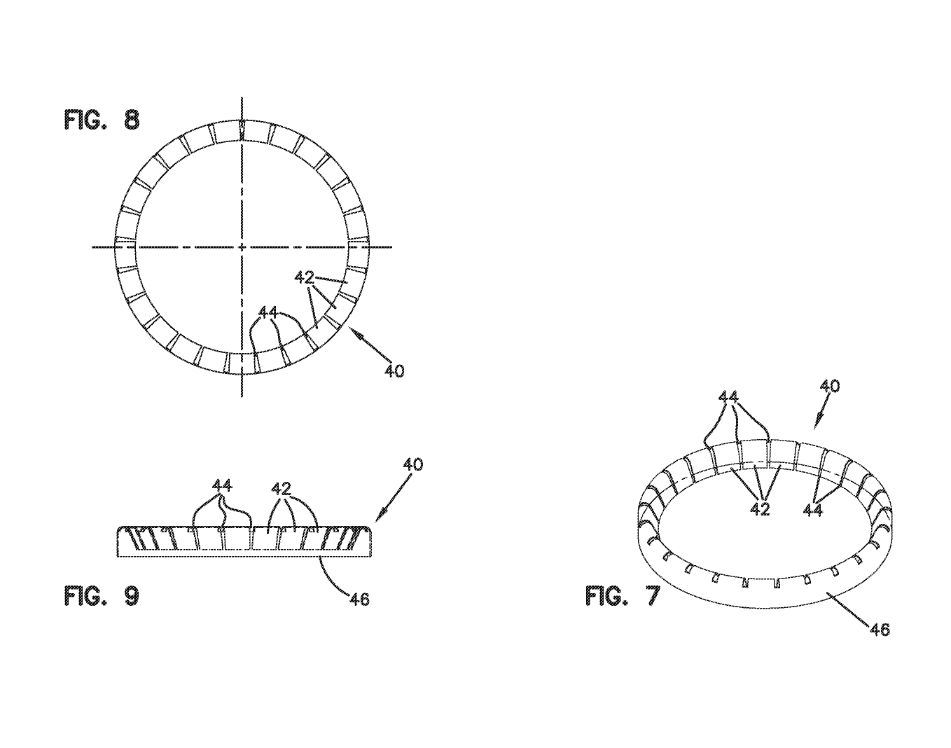

Referring now to FIG. 5, the socket (26) is formed into the upper surface of the top electrode (22) as a shallow cylindrical recess. The socket (26) receives the annular contact ring (40) that fits snugly into the socket (26). As shown in FIGS. 7-9, the contact ring (40) includes radially inward extending fingers (42) spaced around the ring. The fingers (42) act as spring like biasing members when engaging the plug and are separated by slits (44). A continuous outer annular portion (46) maintains structural integrity of the contact ring (40).

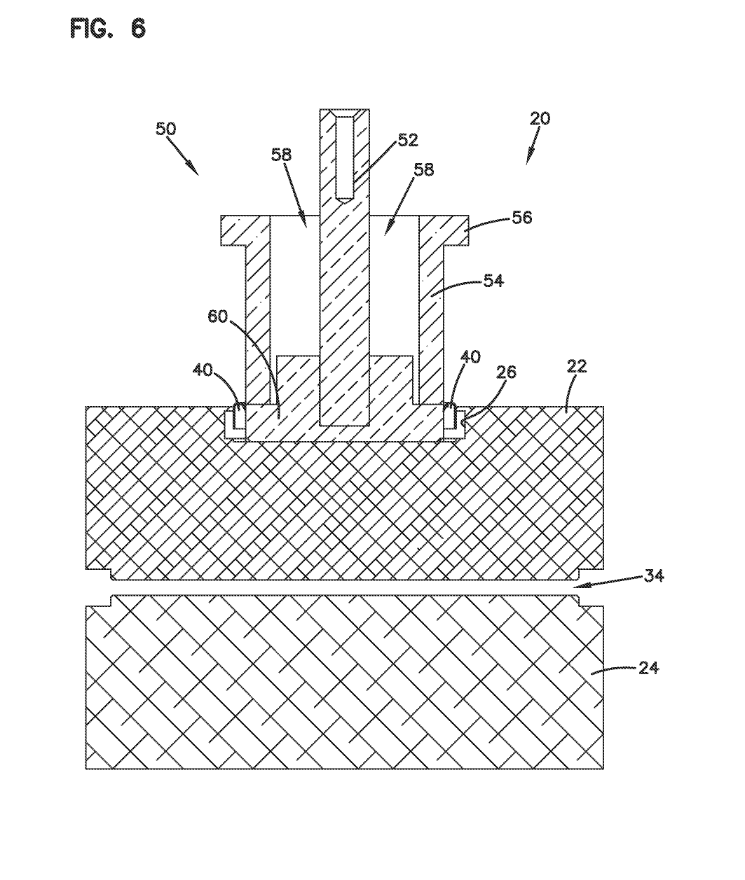

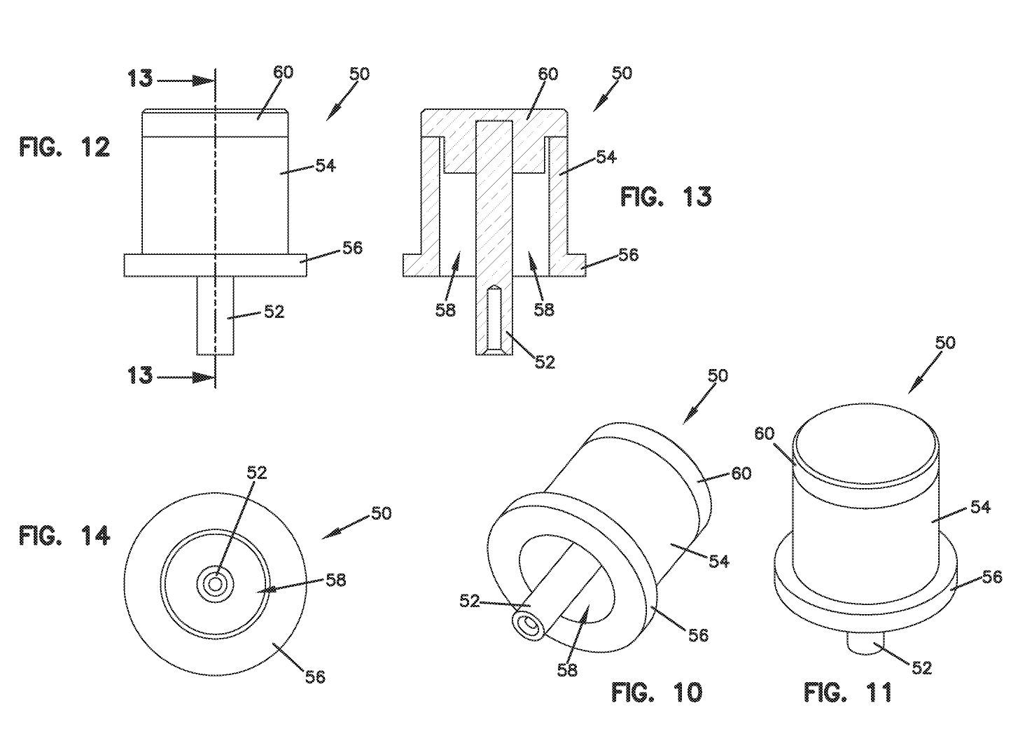

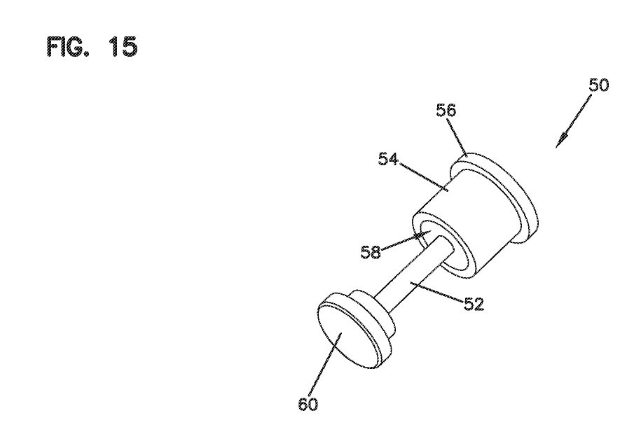

As shown in FIGS. 10-15, the plug (50) is a cylindrical member with a ceramic housing (54) and a gold plated copper center shaft (8) that connects to a copper cap (60). The ceramic housing (54) is mounted to the cap (60) such as with a suitable adhesive. An annular air gap (58) is formed between the ceramic housing (54) and the gold coated copper center shaft (52). The housing (54) forms a lip (56). The RF feed plug (50) inserts into the socket (26) as shown in FIG. 6. The contact ring (40) forms an inner contact diameter that is slightly smaller than the outer diameter of the housing (54) of the plug (50). In this manner, when the plug (50) is inserted into the socket (26) and in the inside of the contact ring (40), the plug (50) engages the inward extending biasing fingers (42). The biasing fingers (42) are therefore pushed outward and become spring loaded to exert an inward biasing force against the plug (50) and provide a retaining force on the plug (50). The arrangement, as shown in FIG. 6 ensures the RF energy fed through the RF plug (50) is dispersed substantially evenly throughout the fingers (42) and into the top electrode (22) and the plasma created inside the vacuum chamber (34). Moreover, the air gap (58) eliminates unwanted ionization and arcing from developing around the in-feed outside of the chamber as may occur in prior art devices. The even distribution of RF energy allows for greater power to be fed through to the laser (20).

To further enhance performance and increased energy capabilities of the present invention, grounding is also enhanced. As shown in FIGS. 2 and 3, the bottom electrode (24) includes multiple spaced apart grounding bars (28). Although four bars are used in the embodiment shown, other configurations may use additional bars depending on the configuration and needs of the particular laser. The grounding bars (28) connect to the housing acting as a ground through a grounding element (70) mounted to the bottom of each grounding bar (28).

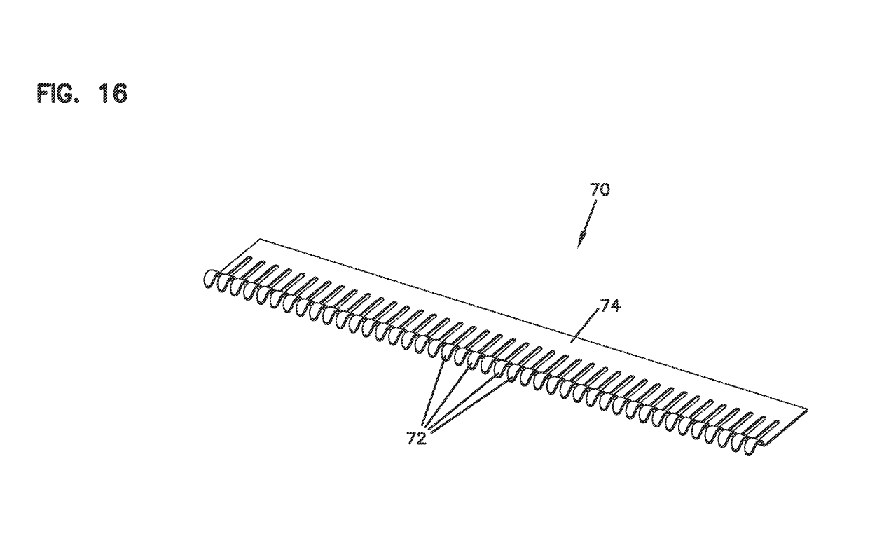

As shown in FIG. 16, each contact element (70) includes an elongated support portion (74) and contact fingers (72) extending along the length of the support portion (74). The contact fingers (72) are similar to the radially inward biasing fingers (42) of the contact ring (40). The contact fingers (72) ensure that energy is dispersed along all fingers (72) rather than focused at a single point. This improves grounding by creating multiple electrical grounding paths. With multiple grounding bars (28) and multiple contact fingers (72) along each bar (28), the electrical paths are greatly dispersed along the length and width of the laser (20) ensuring greater dispersion.

It can be appreciated that with the improved input of RF energy through the plug (50) and contact ring (40) through a single center socket (26), directing of energy radially outward through the contact fingers (42) and with multiple grounding bars (28) and contact fingers (72) spreading along the length and width of the laser, energy is spread out for in feed and for grounding in a manner that is not possible with any prior art. This eliminates problems with unwanted ionization or arcing focused at the input or ground points of the laser.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A laser, comprising:
a laser housing;
an upper slab and a lower slab, the upper slab and lower slab forming a vacuum chamber containing a lasing gas;
a first electrode formed by the upper slab and having radio frequency energy applied thereto, the first electrode having a receiving cavity formed in a top surface;
a second electrode formed by the lower slab and serving as a ground electrode;
a contact ring inserting into the cavity of the first electrode, the ring having a plurality of radially inward extending contact members;
a plug connected to a radio frequency energy source and inserting into the cavity in the first electrode and into an interior of the ring and engaging the plurality of radially inward extending contact members; and
a plurality of spaced apart grounding elements extending between the second electrode and the laser housing.

2. The laser according to claim 1, the housing having an orifice formed therein aligned with the receiving cavity.

3. The laser according to claim 1, each of the plurality of grounding elements including a plurality of engagement fingers, the engagement fingers disposed in a parallel side by side arrangement.

4. The laser according to claim 1, the radially inward extending contact members forming an inner contact diameter, the inner contact diameter being smaller than an outer diameter of the plug.

5. The laser according to claim 1, the radially inward extending contact members being deflected upon insertion of the plug.

6. The laser according to claim 3, the engagement fingers being deflected during engagement with the laser housing.

7. The laser according to claim 3, the plurality of grounding elements being spaced apart between the second electrode and the laser housing, each of the engagement elements comprising a plurality of the engagement fingers, the engagement fingers disposed in a parallel side by side arrangement.

8. The laser according to claim 1, wherein the radially inward extending contact members of the ring exert a biasing force on the plug when inserted.

9. The laser according to claim 1, wherein the plug comprises a center conductor shaft and wherein a periphery of the plug comprises an insulator housing.

10. The laser according to claim 9, wherein the insulator housing comprises a ceramic material.

11. The laser according to claim 9, wherein the center conductor shaft and the insulator housing define an air gap there between preventing ionization around the plug outside of the vacuum chamber.

12. The laser according to claim 1, wherein the receiving cavity comprises a substantially cylindrical cavity.
